(19) United States
(12) Patent Application Publication
(10) Pub. No.: US 2022/0127760 A1
(43) Pub. Date: Apr. 28, 2022

(54) TEXTILE YARN WITH ANTIVIRAL PROPERTIES, AND METHODS THEREOF

(71) Applicants: SENAI/CETIQT, Rio de Janeiro (BR); Braskem S.A., Camaçari (BR)

(72) Inventors: Nathan Riany Valerio Albino, Rio de Janeiro (BR); Ricardo Rodrigo Ramos Cecci, Rio de Janeiro (BR); Camila Vicente de Farias, São Paulo City (BR); Igor Lopes Soares, Rio de Janeiro (BR); Vinicius Galhard Grassi, São Paulo City (BR)

(73) Assignees: SENAI/CETIQT, Rio de Janeiro (BR); Braskem S.A., Camaçari (BR)

(21) Appl. No.: 17/509,502

(22) Filed: Oct. 25, 2021

Related U.S. Application Data
(60) Provisional application No. 63/105,080, filed on Oct. 23, 2020.

(51) Int. Cl. D02G 3/44; D02G 3/04

(52) U.S. Cl. CPC D02G 3/449; B82Y 40/00; D02G 3/045

(57) ABSTRACT

A yarn may include at least one filament formed from a polymer composition comprising: a polymer at an amount ranging from 95 wt % to 99.99 wt %; a carbon-based nanomaterial at an amount ranging from 0.01 wt % to 5 wt %. A method may include melt spinning a polymer composition to produce a yarn, where the polymer composition includes a polymer at an amount ranging from 95 wt % to 99.99 wt %; a carbon-based nanomaterial at an amount ranging from 0.01 wt % to 5 wt %.

### BACKGROUND

Polypropylene (PP) is a semicrystalline thermoplastic that has a wide range of applications. One of the myriad uses for PP is the manufacturing of textile yarns. PP yarns have high resistance to bending, fatigue, impact, and abrasion, as well as good thermal and chemical stability and low surface energy. Therefore, PP yarns are used in various textile-based healthcare products as well as a wide variety of non-healthcare products. Graphene is a carbon-based material of nanoscale dimensions that is used in several biomedical applications including protein adsorption, bacterial disinfection, biosensors, antimicrobial activities, and other applications such as an additive for the textile fibers to enhance properties such as UV protection, transparency, flexibility, supercapacity, photocatalytic activity, hydrophobicity, antibacterial effect, and high electrical conductivity. The incorporation of carbon-based nanomaterials in PP yarns may improve one or more of aforementioned properties.

There are prior art references which disclose fibers of PP-carbon-based nanomaterials that have some improved properties. Document CN106192048 discloses a PP-graphene oxide (GO) fiber with thermal stability improvement, and document CN108048936 discloses a PP-modified GO fiber with high strength, antistatic, flame-retardant, and antibacterial properties. It is also well known that graphene has antiviral properties. However, a PP-carbon-based nanomaterial yarn with antiviral properties has not yet been achieved and described. Document CN111441102 describes an antiviral polyester (PES)/GO/chitin sulfate/polyester polyurethane fiber. Obtaining an antiviral PP-carbon-based nanomaterial yarn has some challenges, such as the compatibilization and dispersion of the carbon-based nanomaterial in the polymer matrix. Polyester and polar polymers have better compatibilization with carbon-based nanomaterial as graphene oxide than hydrophobic polymers such as PP. Document WO2021097544 discloses a melt spinning process with a pre-dispersion step for polyester(PES)/graphene oxide (GO) fibers; however, an antiviral property is not mentioned.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a yarn that includes at least one filament formed from a polymer composition comprising: a polymer at an amount ranging from 95 wt % to 99.99 wt %; a carbon-based nanomaterial at an amount ranging from 0.01 wt % to 5 wt %.

In another aspect, embodiments disclosed herein relate to a fabric that includes a yarn including at least one filament formed from a polymer composition comprising: a polymer at an amount ranging from 95 wt % to 99.99 wt %; a carbon-based nanomaterial at an amount ranging from 0.01 wt % to 5 wt %.

In another aspect, embodiments disclosed herein relate to an antiviral article that includes a fabric that includes a yarn including at least one filament formed from a polymer composition comprising: a polymer at an amount ranging from 95 wt % to 99.99 wt %; a carbon-based nanomaterial at an amount ranging from 0.01 wt % to 5 wt %.

In yet another aspect, embodiments disclosed herein relate to an antiviral textile that includes a fabric composed by a yarn including at least one filament formed from a polymer composition comprising: a polymer at an amount ranging from 95 wt % to 99.99 wt %; a carbon-based nanomaterial at an amount ranging from 0.01 wt % to 5 wt %. The antiviral article may include surgical masks, PFF2 masks, surgical gowns, lab coats, chair seats, sofas, carpets, packaging, sports clothing and shoes, steering wheel casing, curtains, homemade masks, and personal clothes.

In yet another aspect, embodiments disclosed herein relate to a method that includes melt spinning a polymer composition to produce a yarn, where the polymer composition includes a polymer at an amount ranging from 95 wt % to 99.99 wt %; a carbon-based nanomaterial at an amount ranging from 0.01 wt % to 5 wt %.

Other aspects and advantages of the claimed subject matter will be apparent from the following description and the appended claims.

### BRIEF DESCRIPTION OF THE DRAWING

FIG. 1 is a graph representing measles virus inhibition percentages of exemplary fabrics produced from the yarns of one of more embodiments, and comparative exemplary fabrics produced from conventional yarns.

### DETAILED DESCRIPTION

In an aspect, embodiments disclosed relate to a yarn comprising a polymer composition comprising a polymer and a carbon-based nanomaterial. In particular, embodiments of the present disclosure are directed to yarns that incorporate a carbon-based nanomaterial onto a polymer matrix in order to result in a yarn having antiviral properties.

As mentioned above, obtaining an antiviral PP-carbon-based nanomaterial yarn has some challenges, such as the compatibilization and dispersion of the carbon-based nanomaterial in the polymer matrix. Therefore, achieving good compatibilization between PP and carbon-based nanomaterial is crucial to disperse the nanofiller. In addition, organic nanomaterials such as carbon-based nanomaterials have an ideal concentration range in which the maximum optimization is achieved. Unlike inorganic additives, such as nano silver particles, graphene has a specific concentration range in which the antiviral mechanism is maximized. Also, the type of graphene influences which properties are obtained in the yarn. In addition to the types and concentrations of the graphene, another important aspect is the method of incorporating the graphene particles into the fiber. Application of melt spinning process allows the graphene particles to remain permanently inside the fiber and thus, the antiviral property is not affected due to washing. The anti-viral effect of articles which incorporates such melt-spun fibers containing graphene is diminished only by the natural wear of the fabric. On the contrary, the anti-viral effect of a graphene-coated yarns with the coating technique that also allows the functionalization of fibers and fabrics, fades gradually with washing, because the particles are on the surface of the fiber. In the present disclosure, a PP-carbon-based nanomaterial yarn obtained through melt spinning is described, with optimized parameters and studied concentration of graphene for antiviral purposes.

In particular, embodiments disclosed herein are directed to polymer compositions used to form polymer yarns that have antiviral properties. The term “polymer composition” as used may include a mixture of at least a polymer and another material, which may be a polymer or non-polymer material, which comprise the composition, as well as reaction products and decomposition products formed from the materials of the composition. The term “polymer” refers to a polymeric compound prepared by polymerizing monomers, whether of the same or a different type. The term “carbon-based nanomaterial” refers to a material comprising at least carbon atoms and having particles or constituents of nanoscale dimensions.

In particular, the yarn of the present disclosure may include at least one filament formed from the polymer composition. The term “yarn” is a thread comprising at least one filament that may be used to produce textiles. The term “composite yarn” refers to a “yarn comprising a polymer composition” and may be used interchangeably.

The polymer composition may comprise a polymer or a mixture of polymers at an amount ranging from 95 wt % to 99.99 wt % and a carbon-based nanomaterial at an amount ranging from 0.01 wt % to 5 wt %. In particular embodiments, the carbon-based nanomaterial may be present at an amount having a lower limit of any of 0.01, 0.05, 0.075, 0.09, 0.1 wt % to an upper limit of any of 1, 3, or 5 wt %, where any lower limit can be used in combination with any upper limit. The polymer composition produced by the mixing process may also be referred to as a “masterbatch”. In some embodiments, a polymer composition or a masterbatch may have a homogeneous distribution of the carbon-based nanomaterial. The referred masterbatch may be obtained through a melt mixing technique, where the graphene particles may be physically mixed with the PP pellets and added to the feed hopper of a twin-screw extruder.

In other embodiments, the masterbatch production may include a pre-dispersion process. The pre-dispersion process may include cryogenic grinding of the polymer in a knife mill and might be followed by sieving, obtaining polymer particles ranging from 0.15 mm to 1.5 mm. The carbon-based nanomaterial can be suspended in water or ethyl alcohol, with the concentration of the referred nanomaterial ranging from 1.0 g/L to 7.0 g/L. The pre-suspended carbon-based nanomaterial may be mixed with the milled and sieved polymer. The mixture (suspension+polymer) may be dried with a heating bath (−60° C.), vacuum, and constant rotation. The solid mixture can be twice extruded in a twin-screw extruder, with temperature ranging from 140° C. to 180° C. in the first extrusion and from 150° C. to 220° C. in the second extrusion. The nanocomposite obtained from this step can be referred to as a masterbatch.

In one or more embodiments, the polymer comprises semicrystalline thermoplastics. The term “semicrystalline thermoplastics” refers to a polymer material having a highly ordered molecular structure with sharp melting points and is capable of repeatedly becoming pliable or moldable at a certain temperature and solidifying upon cooling.

In one or more embodiments, the polymer composition may include a polyolefin. Comprises one or more polyolefins selected from the group consisting of polypropylene, polyethylene, ethylene vinyl acetate (EVA), and combinations thereof. Further, it is also envisioned that the polymer composition may include homopolymers, copolymers, or blends of multiple grades of the same or different polymer types. In some embodiments, the polyolefins may include polymers generated from petroleum-based monomers and/or biobased monomers (such as ethylene obtained from sugarcane derived ethanol). In some embodiments, the polymer composition may include virgin or recycled polyolefins. Recycled polyolefins may include post consumer resin (PCR), post-industrial resin (PIR), and/or regrind. PCR refers to resin that is recycled after consumer use thereof, whereas PIR refers to resin that is recycled from industrial materials and/or processes (for example, cuttings of materials used in making other articles). When the materials are recovered directly from the same manufacturing process, the materials may be referred to as regrind.

Polyolefins include polymers produced from unsaturated monomers (olefins or “alkenes”) with the general chemical formula of CₙH₂ₙ. In some embodiments, polyolefins may include ethylene homopolymers, copolymers of ethylene and one or more C3-C20 alpha-olefins, propylene homopolymers, heterophasic propylene polymers, copolymers of propylene and one or more comonomers selected from ethylene and C4-C20 alpha-olefins, olefin terpolymers and higher order polymers, and blends obtained from the mixture of one or more of these polymers and/or copolymers. In particular embodiments, the polymer may be polypropylene. Example polypropylene grades include H125, H201, CP360H, PF260GQ, all of which are commercially available from Braskem. In some embodiments, the polyolefins may also include polyethylene including low density polyetheylene (LDPE), linear low density polyetheylene (LLDPE), medium density polyethytlene (MDPE) and high density polyethytlene (HDPE), and polypropylene including homopolymers, random copolymers (RACO), heterophasic copolymers (HECO), and random heterophasic copolymers (RAHECO).

Polymer compositions in accordance with the present disclosure may include an EVA copolymer, wherein the percent by weight (wt %) of ethylene in the biobased EVA ranges from a lower limit selected from any one of 30 wt %. 40 wt %, 45 wt %, 50 wt %, 55 wt %, 60 wt %, 66 wt %, and 72 wt %, to an upper limit selected from any one of 80 wt %, 82 wt %, 88 wt %, and 92 wt %, where any lower limit may be paired with any upper limit. Similarly, polymer compositions in accordance with the present disclosure may include a EVA copolymer having a wt % of vinyl acetate content as determined by ASTM D5594 that ranges from a lower limit selected from any one of 8 wt %, 12 wt %, 15 wt %, 17 wt %, 18 wt %, 20 wt %, 26 wt %, and 28 wt % to an upper limit selected from any one of 28 wt %, 30 wt %, 33 wt %, 35 wt %, 40 wt %, and 45 wt %, where any lower limit may be paired with any upper limit.

In one or more embodiments, the polymer is a polypropylene having a melt flow index that ranges from about 0.75 g/10 min to about 50 g/10 min as measured in accordance with ASTM 1238 at 230° C. under a 2.16 kg load. For example, the polypropylene may have a melt flow index that ranges from a lower limit of any of 0.75, 1, 2, 5, 10, or 20 g/10 min, to an upper limit of any of 40, 45, or 50 g/10 min, where any lower limit can be used in combination with any upper limit.

In one or more embodiments, the carbon-based nanomaterial comprises a graphene-based nanomaterial. The term “graphene-based nanomaterial” refers to a two-dimensional material with one or more layers of carbon atoms tightly bound in a hexagonal honeycomb lattice and having particles or constituents of nanoscale dimensions. The graphene-based nanomaterial may have a thickness ranging from 0.3 nanometer (nm) to 10 nm and an average diameter ranging from 0.5 μm and 20 μm. In one or more embodiments, the graphene-based nanomaterial may have a thickness ranging from a lower limit of any of 0.3, 0.5, or 0.8 nm, and an upper limit of any of 8, 9, or 10 nm, where any lower limit can be used in combination with any upper limit. In one or more embodiments, the graphene-based nanomaterial may have an average diameter ranging from a lower limit of any of 0.5, 1.0, or 1.5 μm and an upper limit of any of 15, 20, or 20 μm, where any lower limit can be used in combination with any upper limit.

In one of more embodiments, the graphene-based nanomaterial comprises one or more selected from the group consisting of graphene oxide, reduced graphene oxide and modified graphene oxide. The term “graphene oxide” refers to a graphene-based nanomaterial that may have various oxygen-containing functionalities. “Reduced graphene oxide” refers to a graphene oxide which some oxygen groups are removed or “reduced” through various processes including electrochemical reduction, chemical reduction and thermal reduction. The term “modified graphene oxide” refers to a graphene oxide with additional modification of its intrinsic structure by functionalization, including but not limited to functional modification of covalent bonds, functional modification by non-covalent bond bonding, and element doping.

In one or more embodiments, the graphene-based nanomaterial may have a surface area ranging from 100 m²/g to 2600 m²/g, a purity ranging from 90 wt % to 99.9 wt % (for example, a more particular range of 95 to 98 wt %) and a density ranging from 0.01 g/cm³ to 3 g/cm³.

In one or more embodiments, the graphene-based nanomaterial may have a carbon to oxygen ratio ranging from 1.5:1 to 4:1.

The yarn comprising a polymer composition in one or more embodiments may be prepared by conventional production processes utilized in the textile and other industries to produce polymer yarns. An example of such processes is a melt spinning process. In one or more embodiments, the yarns of the present disclosure may be formed by a melt spinning process that includes at least a mixing process, a spinning process and a drawing process.

In one or more embodiments, the mixing process of the melt spinning process may produce a polymer composition. Specifically, an extruder is used to melt at least a polymer by heating above its melting temperature and then adding at least a carbon-based nanomaterial therein to produce a polymer composition. The processing temperature of the mixing process may be from 100° C. to 250° C., and the screw rotational speed may be from 30 rotations per minute (30 rpm) to 100 rpm.

In the “spinning process” and “drawing process” of the melt spinning process, a spinning and drawing machine system, such as a single-screw extruder or an interpenetrating co-rotational twin-screw extruder, a multifilament matrix and a drawing machine composed of 4 Godet type rollers, may be used. Embodiments may produce a partially oriented yarn (POY) or a draw textured yarn (DTY) in the drawing process. The spinning process may also have a spin pump speed ranging from about 10 rpm to about 40 rpm, melt pressure from about 70 bar to about 100 bar and a screw speed of about 10 rpm to about 40 rpm, which may be adjusted automatically. The spinning process may have a process temperature ranging from about 100° C. to about 250° C., and a draw ratio ranging from about 2 to about 8.

In one or more embodiments, the yarn comprising the polymer composition comprising a polymer and a carbon-based nanomaterial may undergo a continuous cooling process in the spinning process. The continuous cooling process may be performed by compressed air and the yarn may be cooled to about 25° C. The continuous cooling process may also be performed to keep the temperature of the yarn above the glass transition temperature (T_{g}) of the polymer composition.

In the drawing process, the yarn comprising the polymer composition comprising a polymer and a carbon-based nanomaterial may be drawn by a plurality of Godet rolls under an elevated temperature. The drawing process may have a processing temperature from about 70° C. to about 150° C., a draw ratio from about 2 to about 8 and a rotational speed of the godet rolls from about 50 m/min to about 800 m/min.

In one or more embodiments, the yarn may be in a form of continuous filaments and may wound onto a tube, such as a cardboard tube, after the drawing process. The tube may have any dimensions conventionally used in the drawing process.

The yarn comprising the polymer composition comprising a polymer and a carbon-based nanomaterial in one or more embodiments may comprise a monofilament, a bi-component filament, or a multicomponent filament. The “monofilament” refers to a single strand of filament comprising a polymer composition comprising a polymer and a carbon-based nanomaterial. “Bi-component filament” refers to filament comprising two materials. The two materials may be two different types of polymer compositions comprising a polymer and a carbon-based nanomaterial, or a polymer and a polymer composition comprising a polymer and a carbon-based nanomaterial. The bi-component filament may include a side-by-side filament, a core and sheath filament, a segmented filament or islands-in-the-sea filament. “Multicomponent filament” may be a bi-component filament or a filament comprising three or more materials. The three or more materials may be three different types of polymer compositions comprising a polymer and a carbon-based nanomaterial or a combination of different types of polymers and polymer compositions comprising a polymer and a carbon-based nanomaterial provided that at least one material is a polymer composition comprising a polymer and a carbon-based nanomaterial. The multicomponent filament may also include a side-by-side filament, a core and sheath filament, a segmented filament or islands-in-the-sea filament. The filaments and yarn may have a homogenous distribution of carbon-based nanomaterial (such as graphene oxide) on the filament and yarn formed therefrom. The homogenous distribution of carbon-based nanomaterial may be evaluated by performing Transmission Electron Microscopy (TEM) and Scanning Electron Microscopy (SEM) and determining the level of nanomaterial agglomeration.

In another aspect, embodiments disclosed relate to a yarn having improved thermal stability. “Thermal stability” refers to as the ability of a material to resist the action of heat and maintain its properties. Thermal stability of a yarn may be determined, for example, by utilizing thermogravimetry and obtaining a temperature at which the materials start to decompose in accordance with ASTM E2550-11 “Standard test method for thermal stability by thermogravimetry”. An increase in a thermal stability of the yarn comprising the polymer composition including a polymer and a carbon-based nanomaterial, when compared to a thermal stability of a yarn comprising at least one filament formed from a polymer composition including the same polymer (without carbon-based nanomaterial) may be 5% or more, 10% or more, 15% or more, or 20% or more, in one or more embodiments.

In yet another aspect, embodiments disclosed related to a yarn having improved tenacity and improved elastic modulus. The tenacity and elastic modulus of a yarn may be determined, for example, in accordance with ISO 2062:2009 “Textiles from packages—Determination of single-end breaking force and elongation at break using constant rate of extension (CRE) tester”. An increase in a tenacity of the of the yarn comprising the polymer composition including a polymer and a carbon-based nanomaterial, when compared to a thermal stability of a yarn comprising at least one filament formed from a polymer composition including the same polymer (without carbon-based nanomaterial) may be 5% or more, 7.5% or more, 10% or more, 15% or more, or 20% or more, in one or more embodiments. An increase in an elastic modulus of the of the yarn comprising the polymer composition including a polymer and a carbon-based nanomaterial, when compared to a thermal stability of a yarn comprising at least one filament formed from a polymer composition including the same polymer (without carbon-based nanomaterial) may be 20% or more, 25% or more, 30% or more, or 35% or more, in one or more embodiments.

In another aspect, embodiments disclosed relate to a yarn having antiviral properties. “Antiviral properties” refer to as properties of a material which kill microorganisms including bacteria and viruses or suppress their ability to replicate and inhibits their capability to multiply and reproduce. Antiviral properties of a yarn may be tested in a form of a fabric. A fabric comprising a yarn comprising a polymer composition comprising a polymer and a carbon-based material is disclosed in a later section. Antiviral properties may be evaluated utilizing a test method such as AATCC 100 and ISO 18184 “Determination of antiviral activity of textile products”. An exemplary test procedure to determine the antiviral properties may be as follows. A sample of a fabric produced from the yarn comprising a polymer composition comprising a polymer and a carbon-based nanomaterial, and a comparative sample of yarn produced from a polymer composition including the polymer (without the carbon-based nanomaterial) may be inoculated with microorganisms such as bacteria and virus. Immediately after the contact, elution may be carried out in a neutral solution followed by dilution using the neutral solution. The solution of the sample and the blanks may be seeded on agar plates and incubated for 24 hours at 37° C. +/−2° C. Subsequently, the number of microorganisms in the agar plates seeded with the solution of the sample and blanks are counted and compared. The difference between the number of microorganisms in the treated sample and the blanks may be considered as virus growth reduction or inhibition. The percent virus inhibition or virus inhibition % may be calculated as follows:

$$virus inhibition \% = 100 - \frac{average count of virus in treated sample}{average count of virus in blank sample} \times 100 \qquad ( 1 )$$

In one or more embodiments, the yarn may have antiviral properties with wash resistance. That is, in one or more embodiments, washing the fabric does not have an impact on the antiviral properties of the yarn. The antiviral properties with wash resistance may be determined by obtaining a fabric comprising a yarn comprising a polymer composition comprising a polymer and a carbon-based material and conduct a test in accordance with AATCC 100 or ISO 18184 for example, after the fabric has been washed at least one hundred times, or more in one or more embodiments. The washing process may be conducted, for example, in accordance with ISO 6330:2012, and by utilizing a conventional washing machine.

In another aspect, embodiments disclosed relate to a fabric comprising the yarn comprising a polymer composition comprising a polymer and a carbon-based nanomaterial. The fabric may be produced by a conventional textile manufacturing processes. In one or more embodiments, the fabric may be a woven fabric, a knitted fabric, a non-woven fabric or a continuous filament fabric. The woven fabric and knitted fabric may contain a continuous filament yarn or a spun yarn. The fabric may comprise one type of yarn, or a two or more types of yarn.

In another aspect, embodiments disclosed relate to a continuous filament fabric comprising the yarn having antiviral properties. The antiviral properties may be evaluated by obtaining the virus inhibition % of the continuous filament fabric comprising the yarn. In some embodiments, the continuous filament fabric having antiviral properties may have the virus inhibition % of at least 40%, 50%, 60%, or 70%. In some embodiments, the virus inhibition % of the continuous filament fabric may range from 40% to 99.9999%.

In another aspect, embodiments disclosed relate to an antiviral article comprising the fabric having antiviral properties. In some embodiments, the antiviral articles comprising the fabric may have a virus inhibition % ranging from 40% to 99.9999% or at least 40%, 50%, 60%, or 70%. The antiviral article may include surgical masks, filtering facepiece respirators (such as but not limited to N95 (certified under NIOSH-42CFR84), FFP2 (certified under EN 149-2001), and PFF2 (certified under ABNT/NBR 13.698-2011)), surgical gowns, lab coats, chair seats, sofas, carpets, mattresses, packaging, sports clothing and shoes, steering wheel casing, curtains, homemade masks, and personal clothes.

In another aspect, embodiments disclosed relate to an antiviral personal protective equipment (PPE) comprising a fabric comprising the yarn comprising a polymer composition comprising a polymer and a carbon-based nanomaterial. The antiviral PPE may include surgical masks and aprons. The test methods to determine whether the antiviral PPE meet the requirement may include ABNT NBR 15052:2004, ABNT NBR 16064:2016 for aprons and ABNT NBR 14673:2002, ABNT NBR 13698:2011 and ASTM F2100 for surgical masks.

In yet another aspect, embodiments disclosed herein related to a method of forming the yarn comprising at least one filament that includes melt spinning the polymer composition comprising the polymer and the carbon-based nanomaterial.

It is also envisioned that the polymer composition described herein comprising a polymer and a carbon-based nanomaterial may also be used to produce molded articles, such as automotive parts and furniture, produced by various conventional methods such as injection molding, compression molding, thermoforming, roto-molding and the like.

### EXAMPLES

### Example 1

A yarn comprising a polymer composition comprising 99.90 wt % of polypropylene and 0.10 wt % of graphene oxide was produced by the melt spinning process. The temperature between the feed zone and pumping zone was maintained between 50° C. and 245° C. and then the pre-dispersed masterbatch comprising 99.90 wt % of polypropylene and 0.10 wt % of graphene oxide was added. Subsequently, the spinning process and drawing process were performed in a spinning drawing machine system (CMF 100, Dr. Collin, Germany). The spinning and drawing machine system utilized had a single-screw extruder with a length to diameter ratio of 25 (Extruder E20T, Dr. Collin, Germany), a multifilament matrix, and a draw texturing machine with 4 Godet type rollers. The matrix had a circular-cross-section drawing frame measuring 115 mm in diameter and contained 24 to 144 capillaries with a diameter (ϕ) of 0.17 mm. Melt spinning was conducted at 50° C. at the feed zone, 245° C. at the pumping zone, and temperatures ranging from 50° C. to 245° C. in different heating zones between the feed zone and the pumping zone. Extrusion was conducted at a spin pump speed of 20 rpm, a melt pressure of 50 bar, and the screw speed from 20 rpm to 30 rpm which was adjusted automatically.

Subsequently, the yarn was continuously cooled with compressed synthetic air to a temperature of 25° C., which is above T_{g} and the yarn was drawn by 4 Godet rolls. The yarn was heated from about 80° C. to 130° C. The drawing rates ranged between 2 and 5 and the rotational speed of 4 Godet rolls was about 50 m/min to 305 m/min. The drawn fiber was then wound onto a cardboard tube with an internal diameter of 65 mm and an external diameter of 260 mm.

### Example 2

A yarn comprising a polymer composition comprising 99.90 wt % of polypropylene and 0.10 wt % of graphene oxide was prepared as described in EXAMPLE 1, except a pre-dispersed masterbatch comprising 99.75 wt % of polypropylene and 0.25 wt % of graphene oxide was mixed and diluted with pristine polypropylene. The mixture was added to the extruder.

### Example 3

A yarn comprising a polymer composition comprising 99.90 wt % of polypropylene and 0.10 wt % of graphene oxide was prepared as described in EXAMPLE 1, except a pre-dispersed masterbatch comprising 99.50 wt % of polypropylene and 0.50 wt % of graphene oxide was mixed and diluted with pristine polypropylene. The mixture was added to the extruder.

### Example 4

A yarn was prepared as described in EXAMPLE 1, except the polymer composition comprised 99.75 wt % polypropylene and 0.25 wt % graphene oxide.

### Example 5

A yarn comprising a polymer composition comprising 99.75 wt % of polypropylene and 0.25 wt % of graphene oxide was prepared as described in EXAMPLE 1, except a pre-dispersed masterbatch comprising 99.50 wt % of polypropylene and 0.50 wt % of graphene oxide was mixed and diluted with pristine polypropylene. The mixture was added to the extruder.

### Example 6

A yarn comprising a polymer composition comprising 99.90 wt % of polypropylene and 0.10 wt % of graphene oxide was produced by the melt spinning process. The temperature between the feed zone and pumping zone was maintained between 100° C. and 245° C. and then a pre-dispersed masterbatch comprising 99.90 wt % of polypropylene and 0.10 wt % of graphene oxide was added. Subsequently, the spinning process and drawing process were performed in a spinning drawing machine system (CMF 100, Dr. Collin, Germany). The spinning and drawing machine system utilized had an interpenetrating co-rotational twin-screw extruder with a length to diameter ratio of 30 (Compounder ZK25T, Dr. Collin, Germany), a multifilament matrix, and a draw texturing machine with 4 Godet type rollers. The matrix had a circular-cross-section drawing frame measuring 115 mm in diameter and contained 24 to 144 capillaries with a diameter (ϕ) of 0.17 mm. Melt spinning was conducted at 100° C. at the feed zone, 245° C. at the pumping zone, and temperatures ranging from 100° C. to 245° C. in different heating zones between the feed zone and the pumping zone. Extrusion was conducted at a spin pump speed and melt pressure adjusted automatically and a screw speed of 60 rpm.

Subsequently, the yarn was continuously cooled with compressed synthetic air to a temperature of 25° C., which is above T_{g} and the yarn was drawn by 4 Godet rolls. The yarn was heated from about 80° C. to 130° C. The drawing rates ranged between 2 and 5 and the rotational speed of 4 Godet rolls was about 75 m/min to 356 m/min. The drawn fiber was then wound onto a cardboard tube with an internal diameter of 65 mm and an external diameter of 260 mm.

### Comparative Example 1

A yarn was prepared as described in EXAMPLE 1, except the polymer composition comprised 100 wt % polypropylene.

### Comparative Example 2

A yarn was prepared as described in EXAMPLE 6, except the polymer composition comprised 100 wt % polypropylene.

The yarns of EXAMPLE (EX) 1-6 and COMPARATIVE EXAMPLE (CEX) 1-2 were processed by a circular knitting machine (Mesdan Twister Lab Machine, Lab Knitter Model, ½ mesh, Fineness: 24″, diameter (ϕ)=3.75″) to produce knitted fabrics with a textile surface with controlled grammage (g/m2). Each knitted fabric was then processed through a “purge” treatment to remove the lubricants applied during the spinning and knitting process. The purge treatment was conducted by utilizing the laboratory laundry at SENAI CETIQT and the process involved immersing the knitted fabric in an aqueous bath solution containing sodium carbonate and a detergent. The purge treatment was performed for about 30 to 50 minutes at a temperature ranging from 70° C. to 100° C.

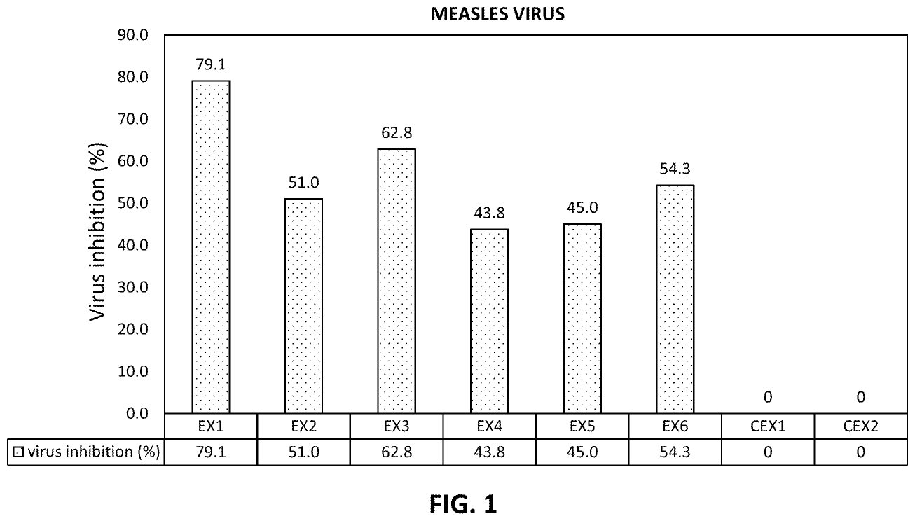

The knitted fabrics obtained from EXAMPLES 1-6 and COMPARATIVE EXAMPLES 1-2 were evaluated according to ISO 18184. All samples are previously evaluated for their ability to induce a cytotoxic effect in the cell model (Vero Cell) used in the antiviral activity assays. Cultures were inoculated with the wash suspension recovered from each sample, and the cytotoxic effect was assessed after one hour of contact/incubation. In addition, the wash suspension recovered from the samples was incubated with the challenge virus (Measles) for 30 minutes, to assess whether additives present in the samples can alter the cellular sensitivity to viral infection, interfering with the analysis of antiviral activity. The virus was recovered and titrated by the Median Tissue Culture Infectious Dose (TCID50) method in Vero cells. The samples were classified as suitable to proceed to the antiviral activity assay when they did not induce a toxic effect on Vero cells and did not interfere with the cellular sensitivity to viral infection, that is, the treated samples did not show a difference greater than 0.5 Log TCID50 against control sample (untreated). All tested samples did not show cytotoxic effect and were evaluated for antiviral activity assay for measles virus, the results of which are shown in FIG. 1. The contact time between the samples and the challenge virus was 30 minutes, with a Serial Dilution (dilution factor of 10) of the samples and virus. The viral titer was quantified with the TCID50 method. The log of TCID50 was converted into a percentage of virus inhibition.

The knitted fabrics obtained from the yarns of EXAMPLE 1 and EXAMPLE 6 were evaluated according to ISO 18184, following the procedure described above. The challenge virus was SARS-CoV-2. The knitted fabric obtained from the yarn of EXAMPLE 1 exhibited 73.7% virus inhibition % and the knitted fabric obtained from the yarn of EXAMPLE 6 exhibited 78.6% virus inhibition for SARS-CoV-2 while COMPARATIVE EXAMPLES 1-2 containing no graphene oxide show no virus inhibition ability. The results demonstrate that a substantial anti-virus property may be obtained from a fabric produced with the yarns of the present disclosure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A yarn, comprising:
at least one filament formed from a polymer composition, comprising:
a polymer at an amount ranging from 95 wt % to 99.99 wt %;
a carbon-based nanomaterial at an amount ranging from 0.01 wt % to 5 wt %.

2. The yarn of claim 1, wherein the polymer comprises a semicrystalline thermoplastic.

3. The yarn of claim 1, wherein the polymer comprises one or more selected from the group consisting of polypropylene, polyethylene, and ethylene vinyl acetate (EVA).

4. The yarn of claim 1, wherein the polymer comprises polypropylene.

5. The yarn of claim 1, wherein the polymer has a melt flow index, measured according to ASTM D1238 at a temperature of 230° C. under a 2.16 kilogram (kg) load, ranging from 0.75 to 50 g/10 min.

6. The yarn of claim 1, wherein the carbon-based nanomaterial comprises a graphene-based nanomaterial.

7. The yarn of claim 6, wherein the graphene-based nanomaterial comprises one or more selected from the group consisting of graphene oxide, reduced graphene oxide, and modified graphene oxide.

8. The yarn of claim 7, wherein the carbon-based nanomaterial comprises graphene oxide.

9. The yarn of claim 6, wherein the graphene-based nanomaterial has a thickness ranging from 0.3 to 10 nm.

10. The yarn of claim 6, wherein the graphene-based nanomaterial has an average diameter ranging from 0.5 to 20 μm.

11. The yarn of claim 6, wherein the graphene-based nanomaterial has a surface area ranging from 100 m²/g to 2600 m²/g.

12. The yarn of claim 6, wherein the graphene-based nanomaterial has a purity ranging from 90 wt % to 99.9 wt %.

13. The yarn of claim 6, wherein the graphene-based nanomaterial has a carbon to oxygen ratio ranging from 1.5:1 to 4:1.

14. The yarn of claim 6, wherein the graphene-based nanomaterial has a density ranging from 0.01 g/cm³ to 3 g/cm³.

15. The yarn of claim 1, wherein the yarn has a virus inhibition % ranging from 40% to 99.9999% when tested in accordance with ISO 18184.

16. The yarn of claim 1, wherein the yarn has a homogeneous distribution of graphene oxide.

17. The yarn of claim 1 wherein the yarn has an increase in a thermal stability of 5% or more, when compared to a thermal stability of a yarn comprising at least one filament formed from a reference polymer composition comprising the polymer without the carbon-based nanomaterial.

18. The yarn of claim 1 wherein the yarn has an increase in a tenacity of 5% or more, when compared to a tenacity of a yarn comprising at least one filament formed from a reference polymer composition comprising the polymer without the carbon-based nanomaterial.

19. The yarn of claim 1 wherein the yarn has an increase in an elastic modulus of 5% or more, when compared to an elastic modulus of a yarn comprising at least one filament formed from a reference polymer composition comprising the polymer without the carbon-based nanomaterial.

20. The yarn of claim 1 wherein the yarn has antiviral properties after washing 100 time or more in accordance with ISO 6330:2012, and when tested in accordance with ISO 18184.

21. The yarn of claim 1, wherein the at least one filament is a monofilament, bi-component filament, or a multicomponent filament.

22. The yarn of claim 1, wherein the yarn is prepared by a melt spinning process.

23. A fabric comprising the yarn of claim 1.

24. The fabric of claim 23, wherein the fabric comprises a woven fabric, a knitted fabric, a non-woven fabric and a continuous filament fabric.

25. The fabric of claim 24, wherein the fabric comprises a continuous filament fabric having antiviral properties.

26. An antiviral article comprising the fabric of claim 23, wherein the antiviral article comprises car seats, sofas or carpet.

27. An antiviral personal protective equipment (PPE) comprising the fabric of claim 23, wherein the PPE is a surgical mask or apron.

28. A method, comprising:
melt spinning a polymer composition to produce a yarn of claim 1, the polymer composition comprising:
a polymer at an amount ranging from 95 wt % to 99.99 wt %;
a carbon-based nanomaterial at an amount ranging from 0.01 wt % to 5 wt %.
